(19) United States
(12) Patent Application Publication
(10) Pub. No.: US 2017/0254471 A1
(43) Pub. Date: Sep. 7, 2017

(54) PORTABLE FOLDABLE SUPPORTING ASSEMBLY

(71) Applicant: Yao Chuan WU, Minhsiung Hsiang (TW)

(72) Inventor: Yao Chuan WU, Minhsiung Hsiang (TW)

(21) Appl. No.: 15/058,800

(22) Filed: Mar. 2, 2016

(51) Int. Cl. F16M 11/38; A47B 23/00

(52) U.S. Cl. CPC F16M 11/38; A47B 23/001

(57) ABSTRACT

A supporting assembly has a supporting board and a baseboard. The baseboard is connected to and located below the supporting board and has a connection end and a folding end. The connection end is connected to the supporting board to allow the supporting board to pivot relative to the baseboard. The folding end is opposite the connection end and has multiple folding segments formed on the folding end.

### BACKGROUND OF THE INVENTION

1. Field of the Invention

The present invention relates to a supporting assembly, and more particularly to a supporting assembly that is portable and foldable.

2. Description of Related Art

A portable device, such as a notebook computer or a tablet computer is popular due to the small volume, light weight, and convenience of use thereof. However, in some public places, such as stations, airports or hospitals, no facilities are provided to allow users to operate portal devices in these public places. Therefore the portable device is usually put on the lap of the user for operation, but this will cause inconvenience of using the portable device. In addition, when the portal device is used in an office, the portable device is put on an office desk. To adjust angle of the screen of the portable device, such as a notebook computer, the screen is pivoted relative to a main body of the computer. However, the pivotal rotation of the screen easily causes damage of hinges between the screen and the main body of the computer. In addition, to adjust an operational angle of an input device, such as a keyboard, is also inconvenient. To overcome the shortcomings, the present invention tends to provide a supporting assembly to mitigate or obviate the aforementioned problems.

### SUMMARY OF THE INVENTION

The main objective of the invention is to provide a supporting device that is portable, foldable, and convenient in adjusting an operational angle of a portable device.

The supporting assembly has a supporting board and a baseboard. The baseboard is connected to and located below the supporting board and has a connection end and a folding end. The connection end is connected to the supporting board to allow the supporting board to pivot relative to the baseboard. The folding end is opposite the connection end and has multiple folding segments formed on the folding end.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a supporting assembly in accordance with the present invention;

FIG. 2 is an exploded perspective view of the supporting assembly in FIG. 1.

FIG. 3 is a cross sectional side view of the supporting assembly in FIG. 1;

FIG. 4 is a cross sectional side view of a first operational embodiment of the supporting assembly in FIG. 1;

FIG. 5 is a cross sectional side view of a second operational embodiment of the supporting assembly in FIG. 1; and

FIG. 6 is a cross sectional side view of a third operational embodiment of the supporting assembly in FIG. 1.

### DETAILED DESCRIPTION OF PREFERRED EMBODIMENT

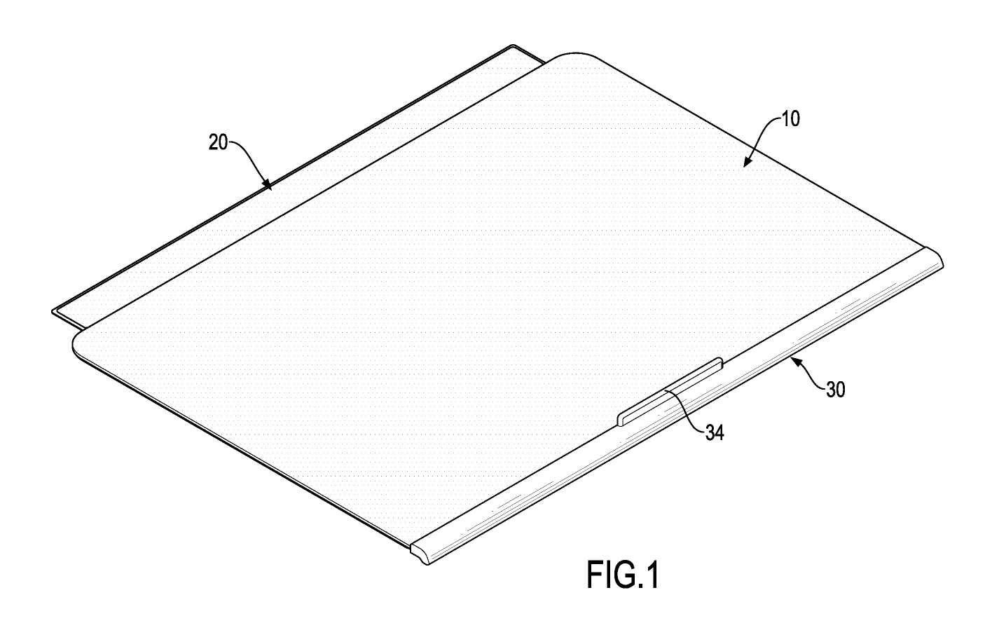

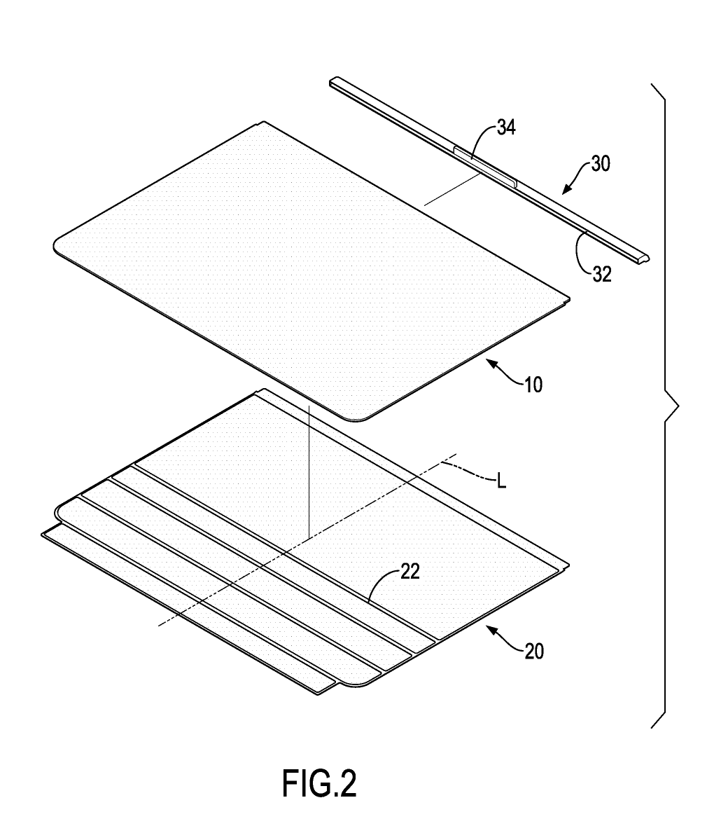

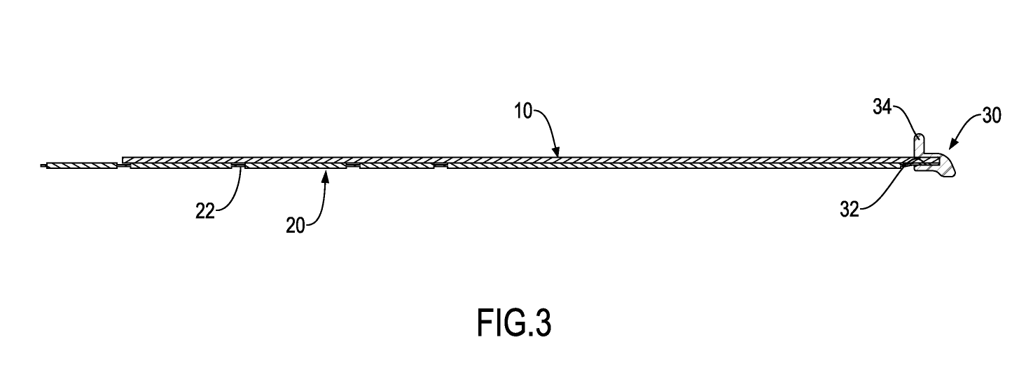

With reference to FIGS. 1 to 3, a supporting assembly in accordance with the present invention comprises a supporting board 10 and a baseboard 20. The supporting board 10 may be a quadrilateral board. The baseboard 20 is connected to and located below the supporting board 10 and has a connection end and a folding end. The connection end is connected to the supporting board 10 to allow the supporting board 10 to pivot relative to the baseboard 20. To connect the supporting board 10 with the baseboard 20, a clamping bar 30 is provided. The clamping bar 30 has an insertion slot 32 defined in the clamping bar 30. The connection end of the baseboard 20 and an edge of the supporting board 10 are inserted into the insertion slot 32 and are clamped by the clamping bar 30 to connect the supporting board 10 with the baseboard 20 by the clamping bar 30. In addition, the clamping bar 30 further has a supporting block 34 formed on and protruding from the clamping bar 30.

The folding end is opposite the connection end and has multiple folding segments 22 formed on the folding end. Each folding segment 22 is a folding strip thinner than remaining parts of the baseboard 20. Preferably, four folding segments 22 are implemented on the folding end of the baseboard 20. The baseboard 20 has a longitudinal direction L, and the multiple folding segments 22 are arranged along the longitudinal direction L and parallel with each other. With the arrangement of the folding segments 22, a polygonal supporting structure can be formed by folding the folding segments 22.

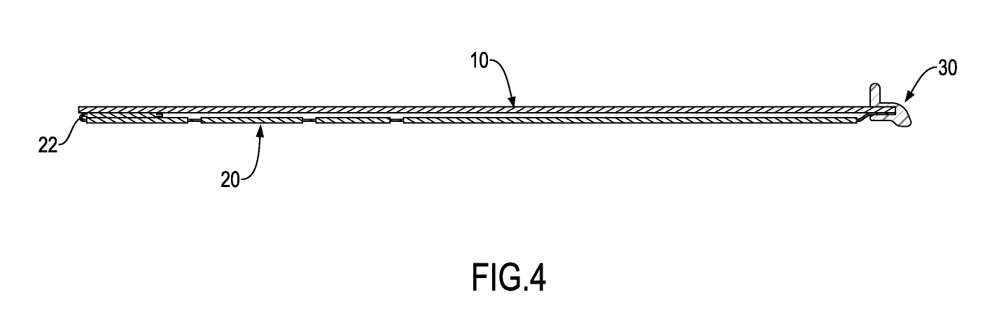

With reference to FIG. 4, when the first folding segment 22 that is the nearest one to the folding end is folded, a flat supporting structure is formed and abuts a bottom of the supporting board 10. Consequently, the supporting board 10 is substantially parallel with the baseboard 20, and the end edge of the supporting board 10 is flush with the folded end edge of the baseboard 20.

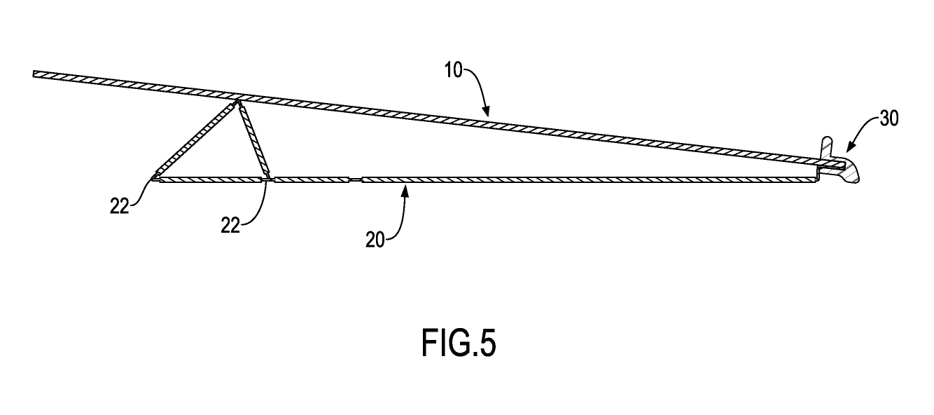

With reference to FIG. 5, when the first and second folding segments 22 are folded and the end edge of the folding end of the baseboard 20 is inserted into the third folding segment 22, a triangular supporting structure is formed and abuts and supports the bottom of the supporting board 10. Consequently, the supporting board 10 is inclined relative to the baseboard 20 at an angle about 5.5 ° to 6.5°.

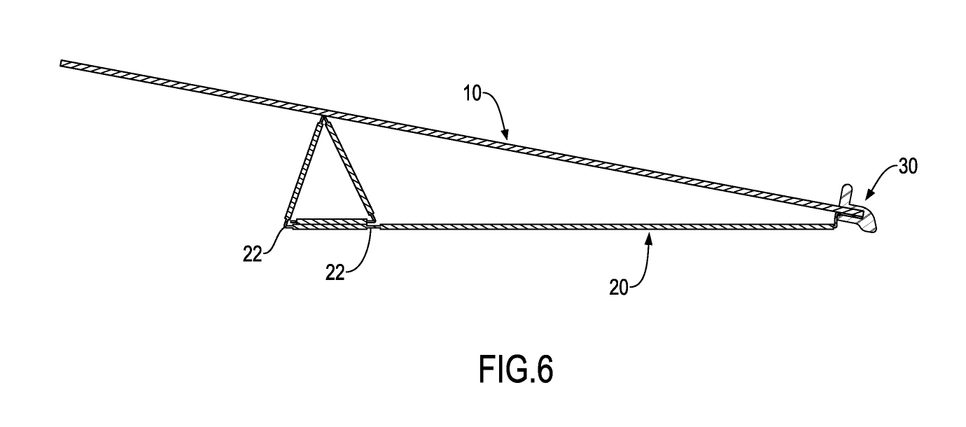

With reference to FIG. 6, when the first, second and third folding segments 22 are folded, a triangular supporting structure having a higher height is formed and abuts and supports the bottom of the supporting board 10. Consequently, the supporting board 10 is inclined relative to the baseboard 20 at an angle about 9° to 10.5°.

Accordingly, the supporting board 10 can be pivoted and adjusted to form different inclined angles relative to the baseboard 20, and a user can use and operate a portable device on the inclined supporting board 10. The operational angle of using the portable device can be conveniently adjusted at the user's demands.

With such a supporting assembly in accordance with the present invention, the folding end of the baseboard 20 can be folded to form diffident supporting structures with different heights. Thus, the supporting board 10 can be supported by the different supporting structures to form different inclined angles relative to the baseboard 20. Accordingly, a user can conveniently use and operate a portal device on the supporting assembly in a public place without putting the portal device on the lap of the user. With the arrangement of the supporting block 34 on the clamping bar 30, the portal device can be kept from falling from the inclined supporting board 10. In addition, the supporting block 34 can be formed on the top of the supporting board 10.

Furthermore, the supporting assembly in accordance with the present invention can be put on an office desk, and a user uses a notebook computer on the supporting assembly. With the adjustment of the angle of the supporting board 10 relative to the baseboard 20, to pivot a screen of the notebook computer relative to a main body of the notebook computer for adjusting an operational angle of the screen is unnecessary. Thus, the hinges between the screen and the main body of the notebook can be kept from being overly pivoted and damaged.

When the supporting assembly is not in use, the folding end of the baseboard 20 can be completely expanded to allow the bottom of the supporting 10 to completely abut the top of the baseboard 20. Accordingly, the volume of the supporting assembly can be minimized, and the supporting assembly can be easily carried and stored.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A supporting assembly comprising:
a supporting board;
a baseboard connected to and located below the supporting board and having
a connection end connected to the supporting board to allow the supporting board to pivot relative to the baseboard; and
a folding end opposite the connection end and having multiple folding segments formed on the folding end.

2. The supporting assembly as claimed in claim 1, wherein each folding segment is a folding strip thinner than remaining parts of the baseboard.

3. The supporting assembly as claimed in claim 2, wherein four folding segments are implemented on the folding end of the baseboard.

4. The supporting assembly as claimed in claim 3, wherein the baseboard has a longitudinal direction; and
the multiple folding segments are arranged along the longitudinal direction and parallel with each other.

5. The supporting assembly as claimed in claim 4 further comprising a clamping bar having an insertion slot defined in the clamping bar; and
the connection end of the baseboard and an edge of the supporting board are inserted into the insertion slot and are clamped by the clamping bar to connect the supporting board with the baseboard by the clamping bar.

6. The supporting assembly as claimed in claim 5, wherein the clamping bar further has a supporting block formed on and protruding from the clamping bar.

7. The supporting assembly as claimed in claim 1, wherein the baseboard has a longitudinal direction; and
the multiple folding segments are arranged along the longitudinal direction and parallel with each other.

8. The supporting assembly as claimed in claim 7 further comprising a clamping bar having an insertion slot defined in the clamping bar; and
the connection end of the baseboard and an edge of the supporting board are inserted into the insertion slot and are clamped by the clamping bar to connect the supporting board with the baseboard by the clamping bar.

9. The supporting assembly as claimed in claim 8, wherein the clamping bar further has a supporting block formed on and protruding from the clamping bar.

10. The supporting assembly as claimed in claim 1 further comprising a clamping bar having an insertion slot defined in the clamping bar; and
the connection end of the baseboard and an edge of the supporting board are inserted into the insertion slot and are clamped by the clamping bar to connect the supporting board with the baseboard by the clamping bar.

11. The supporting assembly as claimed in claim 10, wherein the clamping bar further has a supporting block formed on and protruding from the clamping bar.
